(19) United States
(12) Patent Application Publication
(10) Pub. No.: US 2017/0237649 A1
(43) Pub. Date: Aug. 17, 2017

(54) ADJUSTED SPANNING TREE PROTOCOL PATH COST VALUES IN A SOFTWARE DEFINED NETWORK

(71) Applicant: HEWLETT-PACKARD DEVELOPMENT COMPANY, L.P., Houston, TX (US)

(72) Inventors: Rangaprasad SAMPATH, Bangalore (IN); Chivukula KOUNDINYA, Bangalore (IN)

(21) Appl. No.: 15/504,319

(22) PCT Filed: Jan. 26, 2016
(86) PCT No.: PCT/US2016/014798

§ 371 Date: Feb. 16, 2017

(30) Foreign Application Priority Data
Jan. 30, 2015 (IN) 478/CHE/2015

(51) Int. Cl. H04L 12/729; H04L 12/717; H04L 12/26; H04L 12/753; H04L 12/24

(52) U.S. Cl. CPC H04L 45/125; H04L 45/48; H04L 41/147; H04L 43/087; H04L 43/0888; H04L 45/42

(57) ABSTRACT

In some examples, method includes receiving, with a software-defined network (SDN) controller in an SDN containing a plurality of controlled network nodes, a dynamic network parameter for the SDN from a controlled network node in the SDN, selecting, with the SDN controller, an adjusted spanning tree protocol (STP) path cost value for a path cost along a datapath between a source network node and a destination network node in the SDN based on the received dynamic network parameter, and installing, with the SDN controller, the adjusted STP path cost value on controlled network nodes along the datapath.

### BACKGROUND

Computer networks can be used to allow networked devices, such as personal computers, servers, and data storage devices to exchange data. Computer networks often include intermediary datapath devices such as network switches, gateways, and routers, to flow traffic along selected datapaths for routing data between networked devices. Such datapaths can be selected by a network controller, administrator, or another entity, and can, for example, be based on network conditions, network equipment capabilities, or other factors.

### BRIEF DESCRIPTION OF DRAWINGS

FIG. 1 is a diagram of an example software-defined network with traffic along first and second example data paths.

FIG. 2 is a flowchart outlining an example method performed by an example software-defined network controller.

FIG. 3 is a diagram of an example software-defined network controller.

FIG. 4 is a diagram of an example software-defined network controller connected to an example network switch.

FIG. 5 is a diagram of an example machine-readable storage medium.

FIG. 6 is a diagram of an example computing system including the example machine-readable storage medium of FIG. 5.

### DETAILED DESCRIPTION

The Spanning Tree Protocol (STP) is a network protocol that can be used to prevent data loops between network nodes in a network. For example, STP can be used to determine a single loop-free spanning tree data pathway between any two network nodes in the network and can disable links that are not part of the determined spanning tree. STP is designed to optimize the spanning tree based on static network parameters, such as for example link speeds and number of hops between the nodes, but is unable to optimize spanning trees based on dynamic parameters of the network, such as Quality of Service (“QoS”), latency, throughput, power consumption, etc.

Software-defined networking is a technique in which control decisions for routing traffic through the network can be decoupled from the network's physical infrastructure. For example, a software-defined network (SDN) controller can be programmed to receive dynamic parameters of the network from intermediary datapath devices (e.g., network switches), can decide how to route packets over the network, and can inform the devices about these decisions. Because routing decisions in an SDN are made by a centralized controller, this approach is susceptible to transient network loops that can lead to convergence delays.

Certain implementations of the present disclosure seek to address the above issues of STP and SDN by leveraging STP's loop handling ability and SDN's centralized view of the network to allow STP to optimize its determined spanning trees based on dynamic parameters of the network. For example, in some implementations, an SDN controller receives a dynamic network parameter from a controlled network node in the SDN, selects an adjusted STP path cost value for a path cost along a datapath based on the dynamic network parameters, and installs the adjusted STP path cost value on controlled network nodes along the datapath. The spanning tree calculated by the controlled network nodes is then optimized by the network nodes based on the adjusted STP path cost values provided by the SDN controller rather than static parameters, such as link speeds and number of hops between the nodes. Certain implementations of the disclosure can, for example, provide flexibility for optimization of the spanning tree based on one or more dynamic network parameters while avoiding convergence delays and data loops.

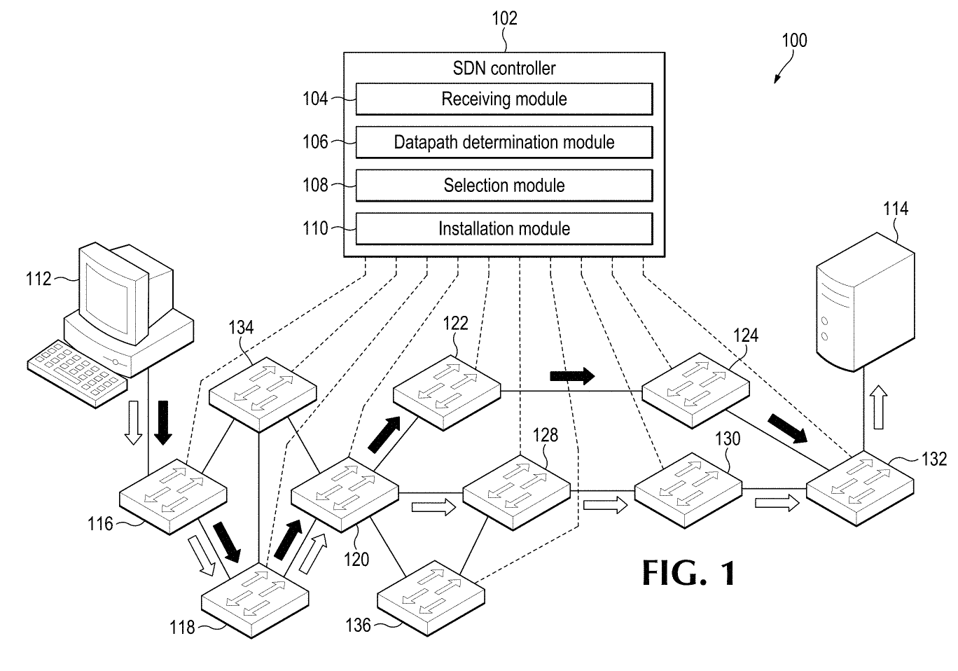

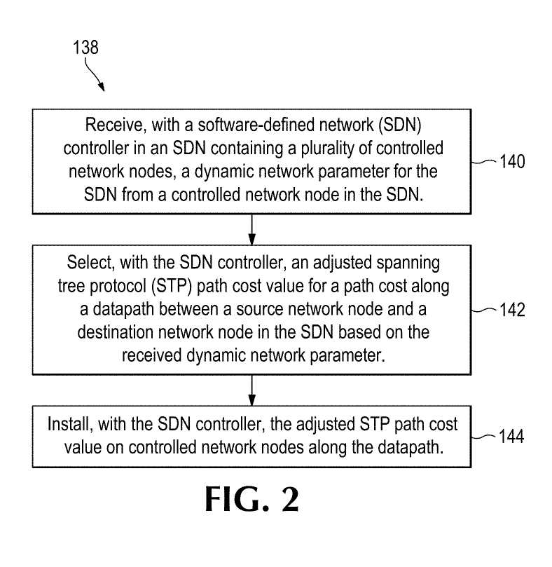

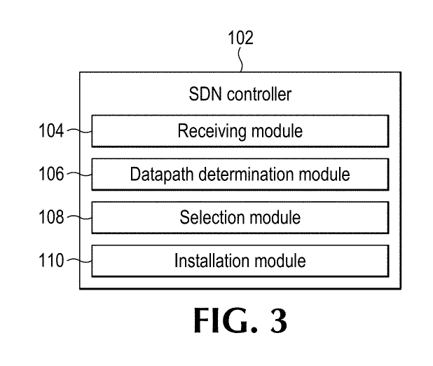

FIG. 1 is a diagram of an example software-defined network (SDN) 100 including an SDN controller 102 having various modules 104, 106, 108, and 110. The structure and functionality of the various modules of SDN controller 102 are described in detail below with respect to FIG. 3. FIG. 1 depicts traffic along a first example datapath between a source node 112 and a destination node 114, the first datapath being defined by network nodes 116, 118, 120, 122, 124, and 126. FIG. 1 also depicts traffic along a second example datapath between source node 112 towards destination node 114. The second datapath is defined by network nodes 116, 118, 120, 128, 130, and 132. For illustration, the first datapath can be determined by STP optimization based on static parameters, such as link speeds and number hops between the nodes, whereas the second datapath can be optimized in accordance with the present disclosure based on one or more dynamic network parameters (e.g., QoS, latency, throughput, power consumption, etc.). Further details regarding suitable dynamic network parameters as well as the process of selecting an adjusted STP path cost value in accordance with the present disclosure are provided below, for example, with respect to the method of FIG. 2.

As provided above, in an SDN, control decisions for routing traffic through the network can be decoupled from the network's physical infrastructure. For example, SDN controller 102 can be used to instruct network nodes to flow traffic along a selected routing path defined by the nodes. In some implementations, these nodes can, for example, be in the form of network switches or other intermediary network devices. The use of such software-defined networking can provide other functionality. For example, one or more SDN applications can be installed on or interface with SDN controller 102 to meet customer use cases, such as to achieve a desired throughput (or another quality of service) over SDN 100, enforce security provisions for SDN 100, or provide another suitable service or functionality.

The functionality of SDN controller 102 can, for example, be implemented in part via a software program on a standalone machine, such as a standalone server. In some implementations, SDN controller 102 can be implemented on multi-purpose machines, such as a suitable desktop computer, laptop, tablet, or the like. In some implementations, SDN controller 102 can be implemented on a suitable non-host network node, such as certain types of network switches. It is appreciated that the functionality of SDN controller 102 may be split among multiple controllers or other devices. For example, SDN 100 is described and illustrated as including only one SDN controller 102. However, it is appreciated that the disclosure herein can be implemented in SDNs with multiple controllers. For example, in some SDNs, network devices are in communication with multiple controllers such that control of the network can be smoothly handed over from a first controller to a second controller if a first controller fails or is otherwise out of operation. As another example, multiple controllers can work together to concurrently control an SDN. In such SDNs, a first controller can, for example, control certain network devices while a second controller can control other network devices. In view of the above, reference in this application to a single SDN controller 102 that controls the operation of SDN 100 is intended to include such multiple controller configurations (and other suitable multiple controller configurations).

Source node 112 and destination node 114 can, for example, be in the form of network hosts or other types of network nodes. For example, one or both of source node 112 and destination node 114 can be in the form of suitable servers, desktop computers, laptops, printers, etc. As but one example, source node 112 can be in the form of a desktop computer including a monitor for presenting information to an operator and a keyboard and mouse for receiving input from an operator, and destination node 114 can be in the form of a standalone storage server appliance. It is appreciated that source node 112 and destination node 114 can be endpoint nodes on SDN 100, intermediate nodes between endpoint nodes, or positioned at other logical or physical locations within SDN 100.

Nodes 116, 118, 120, 122, 124, 126, 128, 130, 132, 134, and 136 within SDN 100 can, for example, be in the form of switches or other multi-port network bridges that process and forward data at the data link layer. In some implementations, one or more of the nodes can be in the form of multilayer switches that operate at multiple layers of the Open Systems Connection (OSI) model (e.g., the data link and network layers). Although the term “switch” is used throughout this description, it is appreciated that this term can refer broadly to other suitable network data forwarding devices. For example, a general purpose computer can include suitable hardware and machine-readable instructions that allow the computer to function as a network switch. It is appreciated that the term “switch” can include other network datapath elements in the form of suitable routers, gateways and other devices that provide switch-like functionality for SDN 100.

Nodes within SDN 100 can forward traffic along a datapath based on metadata within the traffic. For example, traffic received at the node can be in the form of a packet. For illustration, the term “packet” is used herein, however, it is appreciated that “packet” can refer to any suitable protocol data unit (PDU). The packet can, for example, include payload data as well as metadata in the form of control data. Control data can, for example, provide data to assist the node with reliably delivering the payload data. For example, control data can include network addresses for source node 112 and destination node 114, error detection codes, sequencing information, packet size of the packet, a time-to-live (TTL) value, etc. In contrast, payload data can include data carried on behalf of an application for use by source node 112 or destination node 114. Each node within SDN 100, for example, help manage the flow of data across a network by only transmitting a received message to a destination device for which the message was intended (or to an intermediary device en route to the destination device). In some implementations, these nodes can rely on flow entries in flow tables stored on a machine-readable medium within each switch (or otherwise accessible by each switch). Each flow rule in a flow table can, for example, contain information such as: (1) match fields to match against packets (e.g., an ingress port and specific packet header fields), (2) a priority value for the flow rule to allow prioritization over other flow entries, (3) counters that are updated when packets are matched, (4) instructions to modify the action set or pipeline processing, (5) timeouts indicating a maximum amount of time or idle time before a flow is expired by the switch, and (6) a cookie value which can be used by the SDN controller to filter flow statistics, flow modification, and flow deletion.

The various nodes within SDN 100 are connected via one or more data channels, which can, for example be in the form of data cables or wireless data channels. Although a single link between each network node is illustrated, it is appreciated that each single link may include multiple wires or other wired or wireless data channels. For illustration, FIG. 1 depicts SDN controller 102 as being connected to each network nodes via broken lines to illustrate control channels between SDN controller 102 and respective nodes, however it is appreciated that SDN controller 102 may be directly connected to only one or a few network nodes, while being indirectly connected to other nodes of SDN 100. As but one example, SDN controller 102 can be directly connected to node 134 via an Ethernet cable, while being indirectly connected to node 120 (e.g., by relying on node 134 as an intermediary for communication with node 120).

Within the context of an SDN, controlled network nodes can be used as sensors in the network as they have information about dynamic network parameters. When polled via standard SDN interfaces the devices can report this information to the SDN controller. SDN 100 can, for example, be implemented through the use of an SDN controller 102 that interfaces with various SDN-compatible devices via a suitable Application Program Interface (“API”), or another suitable protocol (e.g., OpenFlow). In some implementations, SDN controller 102 may interface with controlled network devices via an interface channel that connects each controlled device to SDN controller 102 to allow SDN controller 102 to configure and manage each device, receive events from each device, and send packets using each device.

As used herein, the term “controlled” and similar terminology in the context of SDN-compatible network nodes, such as “controlled switches,” is intended to include devices within the control domain of SDN controller 102 or otherwise controllable by SDN controller 102. Such a controlled node can, for example, communicate with SDN controller 102 and SDN controller 102 is able to manage the node in accordance with an SDN protocol, such as the OpenFlow protocol. For example, an OpenFlow-compatible switch controlled by SDN controller 102 can permit SDN controller 102 to add, update, and delete flow entries in flow tables of the switch using suitable SDN commands.

In the example SDN 100 depicted in FIG. 1, the various network nodes are in the form of intermediary nodes (controlled network switches 116, 118, 120, 122, 124, 126, 128, 130, 132, 134, and 136) and host devices (source node 112 and destination node 114). It is appreciated however, that the implementations described herein can be used or adapted for networks including more or fewer devices, different types of devices, and different network arrangements. It is further appreciated that the disclosure herein can apply to suitable SDNs (e.g., certain hybrid or heterogeneous SDNs) in which some devices are controlled by an SDN controller and some devices are not controlled by the SDN controller. For example, in some implementations, at least one node along a given datapath is controlled by SDN controller 102 and at least one node along the given datapath is not controlled by SDN controller 102.

FIG. 2 illustrates a flowchart for a method 138 relating to the use of an SDN controller for selecting and installing adjusted STP path cost values based on dynamic network parameters of the SDN. For illustration, the description of method 138 and its component steps make reference to example SDN 100 and elements thereof, such as for example SDN controller 102, node 120, source node 112, destination node 114, etc., however, it is appreciated that method 138 or aspects thereof can be used or otherwise applicable for any suitable network or network element described herein or otherwise. For example, method 138 can be applied to computer networks with different network topologies than those illustrated in FIG. 1.

Method 138 includes a step 140 of receiving, with SDN controller 102 a dynamic network parameter for SDN 100 from a controlled network node in SDN 100. For purposes of illustration, switch 120 of FIG. 1 is used as the controlled network node involved in step 140. It is appreciated, however, that any suitable controlled network node can be used with step 140. The dynamic network parameter can, for example, be received by SDN controller 102 via an SDN communications interface, such as a suitable SDN protocol (e.g., Open Flow). The dynamic network parameter can be requested by SDN controller 102 or can be initiated by switch 120 without being requested by SDN controller 102. In some implementations, SDN controller 102 selects a specific node from which to receive and/or process the dynamic network parameter of step 140. In some implementations, the controlled network node sends the dynamic network parameter to the SDN controller 102 unprompted by SDN controller 102.

The term “dynamic network parameter” as used herein can, for example, refer to real-time or predicted traffic information over SDN 100, and can include, for example, latency, estimated power-consumption across a path, congestion, cost/Mb of a given path, throughput, etc. Dynamic network parameters can, for example, be distinguished from static network parameters, such as link speed and number of hops or other network parameters currently considered by STP. With respect to the dynamic network parameter of power consumption along a given path, power consumption and statistics of physical entities, such as a switch chassis, line cards, individual ports etc., can be reported to SDN controller 102.

It is appreciated that SDN controller 102 can receive multiple dynamic network parameters from one or more controlled network nodes. For example, in some implementations, SDN controller 102 receives a first type of dynamic network parameter (e.g., a latency value or values) from a given controlled network node (e.g., switch 120), and receives a second type of dynamic network parameter (e.g., a throughput value or values) from the same controlled network node (i.e., switch 120) or a different network node. In some implementations, SDN controller 102 receives a first type of dynamic network parameter (e.g., a latency value or values) from a given controlled network node (e.g., switch 120), and receives the same type of dynamic network parameter (i.e., a latency value or values) from the same controlled network node (i.e., switch 120) or a different network node.

In some implementations, the dynamic network parameter received by SDN controller 102 can be processed by the sending controlled network node to include multiple aspects of network traffic. For example, network traffic is often subject to quality-of-service (“QoS”) guarantees, which can help ensure that network resources are used efficiently for multiple applications and services. For example, QoS guarantees can relate to acceptable bandwidths, latencies, error rates, jitter rates, and the like. QoS guarantees are often implemented to ensure a quality experience when using time-sensitive network services, such as real-time multimedia services including Internet Protocol television (IPTV), video calls, online gaming, security camera streams, Voice over IP (VoIP) traffic, or other services. In some implementations, the dynamic network parameter received by SDN controller 102 can correspond to a Quality of Service (“QoS”) metric calculated by the sending controlled network node (e.g., switch 120), which can, for example, combine multiple aspects of network traffic into a single metric.

Method 138 includes a step 142 of selecting, with SDN controller 102, an adjusted STP path cost value for a path cost along a datapath between source node 112 and destination node 114 based on the dynamic network parameter received in step 140. As used herein, the term “STP” can, for example, refer to the Spanning Tree Protocol and/or the Rapid Spanning Tree Protocol defined in IEEE 802.1D (e.g., 802.1D-1990, 802.1D-1998, and 802.1D-2004). The term “STP” as used herein can further refer to other Spanning Tree Protocols such as Multiple Spanning Tree Protocol (MSTP) and Per VLAN Spanning Tree (PVST). The term “STP” can, for example, refer to other similar protocols or techniques for creating a spanning tree within a network of connected layer-2 bridges and disabling links that are not part of the spanning tree, thereby leaving a single active path between two network nodes.

As used herein, the term “adjusted” can refer to modifying an original STP path cost value (e.g., adding to or subtracting from the value) calculated using a standard STP formula or can be a value that is independent of the original STP path cost value. An “original” STP cost can be calculated based on a data rate of a data link between two network nodes. One way in which STP cost can be calculated is using the formula of 1 Gigabit/second divided by the bandwidth of the link. Based on this formula, a link having a bandwidth of 4 Mbit/s would have a path cost of 250, a link having a bandwidth of 500 Mbit/s would have a path cost of 100, a link having a bandwidth of 10 Gbit/s would have a path cost of 2, and so on. For faster link speeds, an alternative way of calculating STP cost can be based on the formula of 20 Terabit/second divided by the bandwidth of the link. Based on this formula, a link having a bandwidth of 4 Mbit/s would have a path cost of 5,000,000, a link having a bandwidth of 10 Mbit/s would have a path cost of 2,000,000, a link having a bandwidth of 10 Gbit/s would have a path cost of 2,000, and so on.

The “adjusted” STP path cost can be a modification of these values based on the dynamic network parameters. For example, in an implementation designed to optimize based on power consumption, a power consumption along a path between a first pair of nodes can be 50 watts, whereas a power consumption along a path between a second pair of nodes can be 100 watts. The adjusted STP path cost can be calculated based on the power consumption values, such that the adjusted STP path cost value between the first pair of nodes is 2,000 and the adjusted STP path cost value between the second pair of nodes is 4,000. Although this example illustrates a linear calculation of adjusted STP path cost, it is appreciated that appropriate alternative calculations can be used. For example, in some implementations, ranged or tiered adjusted STP path cost values can be used. As but one example, all power consumption values below a threshold (e.g., 50 watts) can correspond to a first adjusted STP path cost (e.g., 2,000) whereas power consumption values above the threshold can correspond to a second adjusted STP path cost (e.g., 4,000). It is appreciated that an adjusted STP path cost for network parameter values within a first range of values can be calculated using a first formula (e.g., a linear relationship between the network parameter and the adjusted STP path cost value), and an adjusted STP path cost for network parameter values within a second range of values can be calculated using a second formula (e.g., an exponential relationship between the network parameter and the adjusted STP path cost value).

As used herein, the term “optimized,” “optimization,” and similar terminology can, for example, refer to making a determination or selection to achieve an ideal or otherwise acceptable objective based on available information. For example, optimization of a data path based on power consumption may be calculated so as to minimize power consumption between two nodes, but may in practice result in a higher power consumption than another “non-optimized” data path. For example, it is appreciated that one technique for calculating power consumption may be different than another technique for calculating power consumption such that each technique results in a different “optimized” solution. It is further appreciated, that some optimized solutions may be selected so as to minimize a value (e.g., to minimize power consumption between network nodes), whereas other optimized solutions may be selected so as to maximize a value (e.g., to maximize data throughput between network nodes). Formulas or techniques for determining optimal values can, for example, be provided by a network administrator, or another source.

In some implementations, the adjusted STP path cost value is not calculated using formulas based on the dynamic network parameter, but is instead calculated so as to achieve a desired datapath. For example, in some implementations SDN controller 102 can determine an optimized routing path based on the dynamic network parameter. The SDN controller 102 can then calculate lower adjusted STP path cost values for network nodes along that optimized routing path (e.g., a path cost value of 200) compared to higher adjusted STP path cost values for network nodes not along the optimized routing path (e.g., a path cost value of 20,000). This can allow SDN controller 102 to dictate the spanning tree to be determined using STP. As one example of such an implementation, the adjusted STP path cost value can be selected (or otherwise calculated) so as to route network traffic along a first datapath between source node 112 and destination node 114 predicted to have an increased network throughput compared to a second datapath between source node 112 and destination node 114. As another example of such an implementation, the adjusted STP path cost value can be selected (or otherwise calculated) so as to route network traffic along a first datapath between source node 112 and destination node 114 predicted to have a decreased power consumption compared to a second datapath between source node 112 and destination node 114.

Method 138 includes a step 144 of installing, with SDN controller 102, the adjusted

STP path cost value on controlled network nodes along the datapath. It is appreciated that the adjusted STP path cost value can be installed onto the controlled network nodes along the datapath via an SDN communications interface, such as a suitable SDN protocol (e.g., Open Flow).

In some implementations, method 138 can be implemented so as to prevent a spanning tree or determined datapath between network nodes form being changed too often based on dynamic network conditions. For example, in some implementations, method 138 includes a step of determining, with SDN controller 102, whether an adjusted STP path cost value has not been installed on a controlled network node (e.g., switch 120) within a predetermined period of time (e.g., within 3 minutes). In such an implementation, method 138 can include a step of installing, with SDN controller 102, the adjusted STP path cost value on controlled network nodes along the datapath only when it is determined that the adjusted STP path cost value has not been installed on the controlled network node (i.e., switch 120 in this example) within the predetermined period of time.

Similarly, method 138 can be implemented so as to prevent a spanning tree or datapath from being changed unless the adjusted STP path cost value would result in a significant performance improvement. For example, in some implementations, method 138 can include a step of determining whether installing the adjusted STP path cost value would result in a performance improvement above a predetermined threshold value. In such implementations, method 138 can include an additional step of installing, with SDN controller 102, the adjusted STP path cost value on controlled network nodes along the datapath only when it is determined that installing the adjusted STP path cost value would result in a performance improvement above the predetermined threshold value.

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 138 or other methods described herein in order to achieve the same or comparable functionality. In some implementations, one or more steps are omitted. For example, in some implementations, step 144 of installing the adjusted STP path cost value on controlled network nodes along the datapath is omitted from method 138. It is appreciated that steps corresponding to additional or alternative functionality of other implementations described herein can be incorporated in method 138. For example, steps corresponding to the functionality of various modules of SDN controller 102 can be incorporated in method 138 even if such functionality is not explicitly characterized herein as a step in a method.

FIG. 3 illustrates SDN controller 102 in the form of functional modules that can, for example, be operative to execute one or more steps of method 138 or other methods described herein. For illustration, the description of SDN controller 102 of FIG. 3 make reference to example SDN 100 of FIG. 1 and elements thereof, such as for example SDN controller 102, node 120, source node 112, destination node 114, etc., however, it is appreciated that SDN controller 102 or aspects thereof can be used or otherwise applicable for any suitable network or network element described herein or otherwise. For example, SDN controller 102 can be used with computer networks with different network topologies than those illustrated in FIG. 1.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or at hardware and software hosted at hardware. Additionally, as used herein, the singular forms “a,” “an,” and “the” include plural referents unless the context clearly dictates otherwise. Thus, for example, the term “module” is intended to mean one or more modules or a combination of modules. Each module of SDN controller 102 can include one or more machine-readable storage mediums and one or more computer processors. For example, software that provides the functionality of modules on SDN controller 102 can be stored on a memory of a computer to be executed by a processor of the computer.

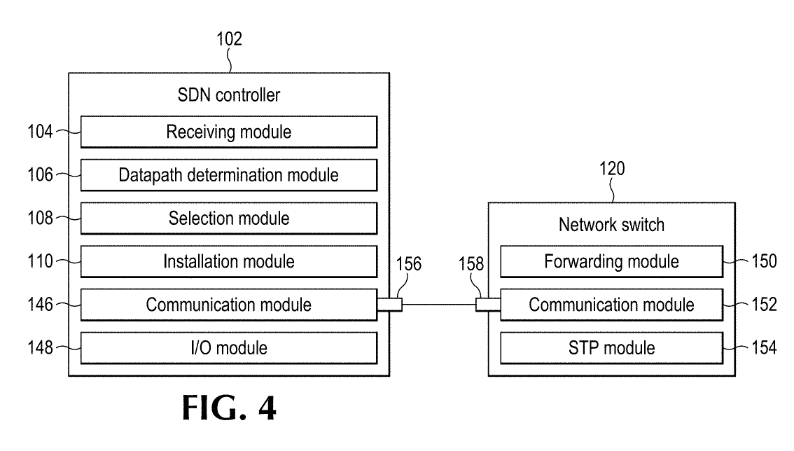

The implementation of SDN controller 102 of FIG. 3 includes receiving module 104, datapath determination module 106, selection module 108, and installation module 110 which were referenced above in FIG. 1 and are described in further detail below. It is appreciated that other modules can be added to SDN controller 102 for additional or alternative functionality. For example, another implementation of SDN controller 102 (described below with respect to FIG. 4) includes additional modules, such as a communication module with a data port.

Receiving module 104 of SDN controller 102 includes a combination of hardware and software to allow SDN controller 102 to receive, from a reporting network node (e.g., switch 120) among a plurality of controlled network nodes, a dynamic network parameter for the SDN sensed by the reporting network node. Receiving module 104 can, for example, include one or more machine-readable storage mediums and one or more computer processors to implement one or more aspects of step 140 (or other steps) of method 138 described above with respect to FIG. 2. For example, in some implementations, receiving module 104 is to receive, from the reporting network node (i.e., switch 120 in this example), multiple types of dynamic network parameters for SDN 100 sensed by the reporting network node.

Datapath determination module 106 of SDN controller 102 includes a combination of hardware and software to allow SDN controller 102 to determine, based on the dynamic network parameter, an optimized datapath between a source node and a destination node in the SDN. Datapath determination module 106 can, for example, include one or more machine-readable storage mediums and one or more computer processors to implement one or more aspects of step 142 (or other steps) of method 138 described above with respect to FIG. 2. For example, in some implementations, datapath determination module 106 is to determine an optimized datapath based on power consumption of multiple datapaths between source node 112 and destination node 114.

Selection module 108 of SDN controller 102 includes a combination of hardware and software to allow SDN controller 102 to select an STP path cost value for a datapath between source node 112 and destination node 114 in order to result in the determined datapath. Selection module 108 can, for example, include one or more machine-readable storage mediums and one or more computer processors to implement one or more aspects of step 142 (or other steps) of method 138 described above with respect to FIG. 2.

Installation module 110 of SDN controller 102 includes a combination of hardware and software to allow SDN controller 102 to install the adjusted STP path cost value on controlled network nodes along the datapath. For example, in some implementations, the adjusted STP path cost values are to be installed only on controlled network nodes along the datapath, whereas in other implementations, the adjusted STP path cost values are to be installed only on controlled network nodes not along the datapath. It is appreciated that in some implementations, the adjusted STP path cost values can be installed on each controlled network node within SDN 100, or along a subset of controlled network nodes within SDN 100. Installation module 110 can, for example, include one or more machine-readable storage mediums and one or more computer processors to implement one or more aspects of step 144 (or other steps) of method 138 described above with respect to FIG. 2.

FIG. 4 illustrates another example of an SDN controller 102 connected to an example network switch (e.g., network node 120) in the form of functional modules that can, for example, be operative to execute one or more steps of method 138 or other methods described herein. Network node 120 is referred to as a network switch for illustration, but it is appreciated that aspects of network node 120 described herein can be incorporated in another suitable network data forwarding device. SDN controller 102 as depicted in FIG. 4 includes receiving module 104, datapath determination module 106, selection module 108, and installation module 110 as described above with respect to FIG. 3. SDN controller 102 of FIG. 4 further includes a communication module 146, and Input/Output (I/O) module 148 as described in further detail below. It is appreciated that various modules of SDN controller 102 of FIG. 3 are depicted in the implementation of SDN controller 102 of FIG. 4 for illustration. However, it is appreciated that SDN controller 102 of FIG. 4 can include alternative, additional, or fewer modules than SDN controller 102 described in FIG. 3. For example, in some implementations, SDN controller 102 of FIG. 4 does not include installation module 110. Example network switch 120 includes forwarding module 150, communication module 152, and STP module 154 as described in further detail below.

Communication modules 146 and 152 of SDN controller 102 and network switch 120 are a combination of hardware and software to allow networked communication between SDN controller 102, network switch 120, and other elements of SDN 100. Communication modules 146 and 152 can include matching or non-matching physical data ports 156, 158 to connect to elements of SDN 100. For example, in some implementations, communication modules 146 and 152 can each include a network interface controller having an Ethernet port, whereas in some implementations, communication module 146 can include an Ethernet port and communication module 152 can include a Fibre Channel port. In some implementations, communication modules 146 and 152 can include wired or wireless communication interface. Communication modules 146 and 152 can, in some implementations, provide for virtual network ports. In some implementations, communication modules 146 and 152 includes hardware in the form of a hard drive, related firmware, and other software for allowing the hard drive to operatively communicate with other hardware of SDN controller 102 or network switch 120. Communication modules 146 and 152 can include information for use with communication modules 146 and 152, such as firmware for implementing physical or virtual network ports.

I/O module 148 of SDN controller 102 is a combination of hardware and software to allow an operator or other entity to view and/or interact with SDN controller 102. Example of suitable I/O modules can include modules for monitors, printers, keyboards, mouses, styluses, touchscreens, speakers, etc. I/O devices for such modules can be connected to elements of SDN controller 102 via wired or wireless links. It is appreciated that network switch 120 can also include an appropriate I/O module of its own.

Forwarding module 150 of network switch 120 includes a combination of hardware and software to allow network switch 120 to extract a set of fields from a received data packets to determine flow routing instructions and to forward the packet according to the flow routing instructions. Network switch 120 can, for example, include one or more machine-readable storage mediums and one or more computer processors, such as the mediums and processors described herein to implement one or more aspects of method 138 or other methods described herein.

STP module 154 of network switch 120 is a combination of hardware and software to create a spanning tree or datapath within a network of connected layer-2 bridges and disabling links that are not part of the spanning tree to thereby leave a single active path between two network nodes. Additional aspects of such STP functionality is described above with respect to method 138. For example, it is appreciated that the STP functionality of STP module 154 can be in accordance with the Spanning Tree Protocol and/or the Rapid Spanning Tree Protocol defined in IEEE 802.1D (e.g., 802.1D-1990, 802.1D-1998, and 802.1D-2004), or other similar protocols or techniques.

It is appreciated that certain modules described herein or otherwise can, in some implementations, share hardware, software, or data with other modules. For example, in some implementations, communication module 146 of SDN controller 102 can share a computer-readable medium with installation module 110, whereas in some implementations, communication module 146 and installation module 110 use separate mediums. It is appreciated that any modules can share hardware, software, or data with any other module in order to achieve their respective objectives.

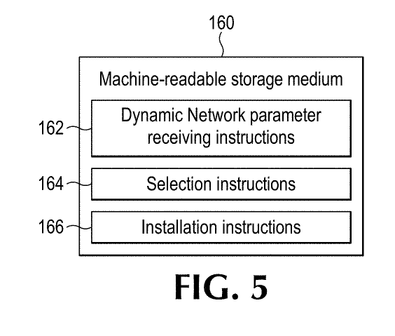

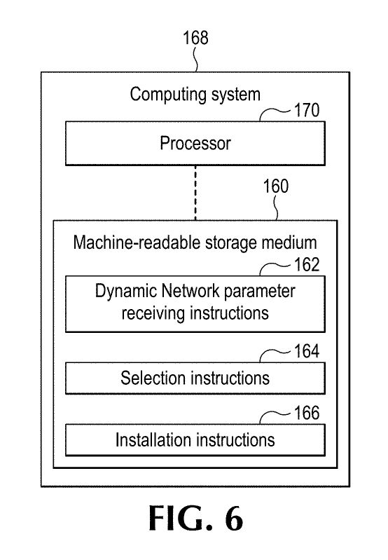

FIGS. 5 and 6 respectively illustrate example machine-readable storage medium 160 (which stores dynamic network parameter receiving instructions 162, selection instructions 164, and installation instructions 166) and an example computing system 168 that includes medium 160. Computing system 168 can, for example, be in the form of an SDN controller or can otherwise provide SDN controller functionality for a network by executing one or more steps of method 138 and/or other methods described herein. The description of computing system 168 refers to elements of SDN 100 for illustration, however, it is appreciated that computing system 168 can be used with any suitable network. Computing system 168 includes a processor 170 and medium 160 as described further below. It is appreciated that computing system 168 can include additional elements, such as input/output (I/O) devices, a communication interface, etc. For example, computing system 168 can include aspects of any suitable module described herein, e.g., the various modules of SDN controller 102 in FIGS. 3 and 4. It is appreciated that one or hardware or software elements for SDN controller 102 described herein may be implemented in computing system 168. In some implementations, software that provides the functionality of SDN controller 102 can be stored on medium 160 of computing system 168 to be executed by processor 170 of computing system 168.

Processor 170 of computing system 168 can, for example, be in the form of a central processing unit (CPU), a semiconductor-based microprocessor, a digital signal processor (DSP) such as a digital image processing unit, other hardware devices or processing elements suitable to retrieve and execute instructions stored in medium 160, or suitable combinations thereof. Processor 170 can, for example, include single or multiple cores on a chip, multiple cores across multiple chips, multiple cores across multiple devices, or suitable combinations thereof. Processor 170 can be functional to fetch, decode, and execute instructions as described herein. As an alternative or in addition to retrieving and executing instructions, processor 170 can, for example, include at least one integrated circuit (IC), other control logic, other electronic circuits, or suitable combination thereof that include a number of electronic components for performing the functionality of instructions stored on medium 160. Processor 170 can, for example, be implemented across multiple processing units and instructions may be implemented by different processing units in different areas of computing system 168.

Medium 160 of computing system 168 can, for example, be in the form of a non-transitory machine-readable storage medium, such as a suitable electronic, magnetic, optical, or other physical storage apparatus to contain or store information such as machine-readable instructions 162, 164, and 166. Such instructions can be operative to perform one or more functions described herein, such as those described above with respect to method 138 or other methods described herein. Medium 160 can include additional network relation information, such as for example, data, such as network performance data relating to SDN 100.

Medium 160 can, for example, be housed within the same housing as processor 170 for computing system 168, such as within a computing tower case for computing system 168. In some implementations, medium 160 and processor 170 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, medium 160 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that instructions and data can be stored on separate machine-readable storage mediums and multiple mediums can be treated as a single medium 160 for purposes of description.

Dynamic network parameter receiving instructions 162 can, for example, run on computing system 168 to receive a first value for a dynamic network parameter for the SDN from a first reporting network node among a plurality of network nodes controlled by the SDN controller and a second value for the dynamic network parameter for the SDN from a second reporting network node among the plurality of network nodes controlled by the SDN controller. Instructions 162 can incorporate one or more aspects of step 140 (and/or other steps) of method 138 described above and/or one or more aspects of receiving module 104 (and/or other modules) of SDN controller 102 or vice versa.

Selection instructions 164 can, for example, run on computing system 168 to select an adjusted STP path cost value to flow data along a datapath between source node 112 and destination node 114 in the SDN that optimizes the dynamic network parameter. Instructions 164 can incorporate one or more aspects of step 142 (and/or other steps) of method 138 described above and/or one or more aspects of selection module 108 (and/or other modules) of SDN controller 102 or vice versa.

Installation instructions 166 can, for example, run on computing system 168 to install the adjusted STP path cost value on controlled network nodes in the SDN. Instructions 166 can incorporate one or more aspects of step 144 (and/or other steps) of method 138 described above and/or one or more aspects of installation module 110 (and/or other modules) of SDN controller 102 or vice versa.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations.

As used herein, the term “provide” includes push mechanisms (e.g., sending data independent of a request for that data), pull mechanisms (e.g., delivering data in response to a request for that data), and store mechanisms (e.g., storing data at an intermediary at which the data can be accessed). Furthermore, as used herein, the term “based on” means “based at least in part on.” Thus, a feature that is described based on some cause, can be based only on the cause, or based on that cause and on one or more other causes.

Furthermore, it should be understood that the systems, networks, and methods described herein can include various combinations and/or sub-combinations of the components and/or features of the different implementations described. Thus, features described with reference to one or more implementations can be combined with other implementations described herein.

What is claimed is:

1. A method comprising:
receiving, with a software-defined network (SDN) controller in an SDN containing a plurality of controlled network nodes, a dynamic network parameter for the SDN from a controlled network node in the SDN;
selecting, with the SDN controller, an adjusted spanning tree protocol (STP) path cost value for a path cost along a datapath between a source network node and a destination network node in the SDN based on the received dynamic network parameter; and
installing, with the SDN controller, the adjusted STP path cost value on controlled network nodes along the datapath.

2. The method of claim 1, wherein the dynamic network parameter is a network throughput value between controlled network nodes in the SDN.

3. The method of claim 1, wherein the dynamic network parameter is a Quality of Service (QoS) between controlled network nodes in the SDN.

4. The method of claim 1, wherein the adjusted STP path cost value is selected so as to route network traffic along a first datapath between the source network node and the destination network node predicted to have an increased network throughput compared to a second datapath between the source network node and the destination network node.

5. The method of claim 1, wherein the adjusted STP path cost value is selected so as to route network traffic along a first datapath between the source network node and the destination network node predicted to have a decreased power consumption compared to a second datapath between the source network node and the destination network node.

6. The method of claim 1, wherein the dynamic network parameter is received by the SDN controller via an SDN communications interface.

7. The method of claim 1, wherein selecting the adjusted STP path cost value includes selecting an adjusted STP path cost value proportional to the dynamic network parameter value received by the SDN controller.

8. The method of claim 1, further comprising:
determining, with the SDN controller, whether an adjusted STP path cost value has not been installed on a controlled network node within a predetermined period of time; and
installing, with the SDN controller, the adjusted STP path cost value on controlled network nodes along the datapath only when it is determined that the adjusted STP path cost value has not been installed on the controlled network node within the predetermined period of time.

9. The method of claim 1, further comprising:
determining, with the SDN controller, whether installing the adjusted STP path cost value would result in a performance improvement above a predetermined threshold value; and
installing, with the SDN controller, the adjusted STP path cost value on controlled network nodes along the datapath only when it is determined that installing the adjusted STP path cost value would result in a performance improvement above the predetermined threshold value.

10. A software-defined network (SDN) controller comprising:
a receiving module to receive, from a reporting network node among a plurality of controlled network nodes, a dynamic network parameter for the SDN sensed by the reporting network node;
a datapath determination module to determine, based on the dynamic network parameter, an optimized datapath between a source network node and a destination network node in the SDN;
a selection module to select an adjusted spanning tree protocol (STP) path cost value for a datapath between the source network node and the destination network node in order to result in the determined datapath; and
an installation module to install the adjusted STP path cost value on controlled network nodes along the datapath.

11. The SDN controller of claim 10, wherein the receiving module to receive, from the reporting network node, multiple types of dynamic dynamic network parameters for the SDN sensed by the reporting network node.

12. The SDN controller of claim 10, wherein the datapath determination module is to determine an optimized datapath based on power consumption of multiple datapaths between the source network node and the destination network node.

13. A non-transitory machine-readable storage medium encoded with instructions executable by a processor of a software-defined network (SDN) controller, the instructions comprising:
dynamic network parameter receiving instructions to receive a first value for a dynamic network parameter for the SDN from a first reporting network node among a plurality of network nodes controlled by the SDN controller and a second value for the dynamic network parameter for the SDN from a second reporting network node among the plurality of network nodes controlled by the SDN controller;
selection instructions to select an adjusted spanning tree protocol (STP) path cost value to flow data along a datapath between a source network node and a destination network node in the SDN that optimizes the dynamic network parameter; and
installation instructions to install the adjusted STP path cost value on controlled network nodes in the SDN.

14. The medium of claim 13, wherein the selection instructions are to select an adjusted spanning tree protocol (STP) path cost value to achieve a spanning tree between each node in the SDN that is optimized based on the dynamic network parameter.

15. The medium of claim 13, wherein the installation instructions are to install adjusted STP path cost values on each controlled network nodes in the SDN.
